(19) United States
(12) Patent Application Publication
(10) Pub. No.: US 2026/0196517 A1
(43) Pub. Date: Jul. 9, 2026

(54) A DRY BATTERY ELECTRODE, A LITHIUM-ION BATTERY AND PROCESSES THEREOF

(71) Applicant: OLA ELECTRIC MOBILITY LIMITED, Bengaluru (IN)

(72) Inventors: Rajesh MEKKAT, Bengaluru (IN); Ramesha R N, Karnataka (IN); Shishir Kumar SINGH, Uttar Pradesh (IN); Vishal SHARMA, Delhi (IN); Aditya RAMADAS, Kannada (IN); Shaik Nagur BABA, Telangana (IN); Sachin Praveen SHET, Karnataka (IN); Lakshmi K P, Kerala (IN); Sooryadas SUDHAKARAN, Kerala (IN); Nityanand KALAKERI, Uttara Kannada (IN); Neelakshi SHARMA, Bengaluru (IN)

(21) Appl. No.: 18/868,455

(22) PCT Filed: Nov. 3, 2023
(86) PCT No.: PCT/IN2023/051015

§ 371 Date: Nov. 22, 2024

(30) Foreign Application Priority Data
Jul. 17, 2023 (IN) 202341048089

(51) Int. Cl. H01M 4/62; H01M 4/02; H01M 4/131; H01M 4/136; H01M 4/1391; H01M 4/1397; H01M 4/505; H01M 4/525; H01M 4/58

(52) U.S. Cl. CPC H01M 4/625; H01M 4/131; H01M 4/136; H01M 4/1391; H01M 4/1397; H01M 4/505; H01M 4/525; H01M 4/5825; H01M 4/623; H01M 2004/021; H01M 2004/028

(57) ABSTRACT

The present disclosure provides a dry battery electrode comprising a. at least one active material; b. at least one a primary conductive carbon, said primary conductive carbon having a BET surface area ranging from 250 m²/g to 1800 m²/g; c. at least one secondary conductive carbon, said secondary conductive carbon having a BET surface area ranging from 10 m²/g to 50 m²/g; and d. at least one binder.

### FIELD OF INVENTION

The present disclosure broadly relates to the field of battery. Particularly, the present disclosure relates to a dry battery electrode and a process for fabricating the electrode. Particularly, the present disclosure relates to a cathode.

### BACKGROUND OF THE INVENTION

Dry coating technology of electrodes has gained significant attention compared to traditional wet slurry process as it provides considerable advantages over wet electrodes. Binder anchoring is a key parameter that fixes the dry coating electrode in a flexible texture. The active material, conductive additive and binder are to be mixed homogeneously to achieve a flexible free-standing film. A shearing force is applied while mixing to transform the binder into fibrils, leading to a matrix formation to blend and support electrode powder together. However, agglomeration of binder along with conductive carbon takes place during high shear mixing. To overcome this problem, tuning of carbon coating on the electrode surface is an advantageous technique to achieve uniform distribution as well as enhanced electrochemical performance of dry electrode batteries.

Tuning of conductive carbon percentage on cathode surface is expected to result in high conductivity of dry electrode along with high peel strength and tensile strength of free-standing film in order to get better electrochemical performance of dry battery electrode. While tuning the weight percentage of conductive carbon, it is to be noted that different conductive carbons exhibit different coating ability on the electrode surface, to anchor the binder. Therefore, incorporation of a dense coating is not enough to improve the electrochemical performance, instead the coating should also improve discharge capacity, initial coulombic efficiency (ICE), capacity retention and electrodes should perform better at high C rates in a range of 1 C to 2 C. Moreover, with an increase in electrode thickness, the electrochemical performance rate and kinetics of lithium in the dry battery decreases. Achieving an optimized conductive carbon coating on the electrode surface will provide better contact between the particles, by which a higher conductivity and better performance is expected for the electrodes. Though a number of strategies have been adopted to address these drawbacks, either the active material loading on the electrode or electronic conductivity is compromised. In addition, nickel-manganese-cobalt (NMC) cathodes inherently suffer from poor conductivity. Thus, there is a dire need in the art to develop cost-effective, cathodes with high-rate performance, enhanced electronic conductivity, improved discharge capacity, initial coulombic efficiency, capacity retention, and improved performance at high C rates in a range of 1 C to 2 C.

### SUMMARY OF THE INVENTION

In an aspect of the present disclosure, there is provided a dry battery electrode comprising: (a) at least one active material; (b) at least one primary conductive carbon having a BET surface area ranging from 250 m²/g to 1800 m²/g; (c) at least one secondary conductive carbon having a BET surface area ranging from 10 m²/g to 50 m²/g; and (d) at least one binder.

In another aspect of the present disclosure, there is provided a process to prepare a dry battery electrode as disclosed herein, said process comprising the steps of: (i) mixing at least one active material, at least one primary conductive carbon, and at least one secondary conductive carbon to obtain a first mixture; (ii) high speed mixing of the first mixture at a speed in a range of 2000 to 4000 rpm, at a temperature in a range of 20 to 40° C. to obtain a second mixture; (iii) adding at least one binder to the second mixture and mixing at a speed in the range of 1000 to 2000 rpm, followed by high shear mixing at a speed in a range of 2000 to 4000 rpm and at a temperature in a range of 50 to 120° C. to obtain a third mixture; and (iv) cooling the third mixture to a temperature less than 19° C. to obtain the electrode.

In yet another aspect of the present disclosure, there is provided a lithium-ion battery comprising: (a) the dry battery electrode as disclosed herein as a cathode; (b) an anode; and (c) an electrolyte.

These and other features, aspects, and advantages of the present subject matter will be better understood with reference to the following description. This summary is provided to introduce a selection of concepts in a simplified form. This summary is not intended to identify key features or essential features of the claimed subject matter, nor is it intended to be used to limit the scope of the claimed subject matter.

### BRIEF DESCRIPTION OF THE FIGURES

The following drawings form a part of the present specification and are included to further illustrate aspects of the present disclosure. The disclosure may be better understood by reference to the drawings in combination with the detailed description of the specific embodiments presented herein.

FIG. 1 depicts the scanning electron microscopic (SEM) images of dry battery electrodes comprising different conductive carbon combinations, wherein (a) uncoated NMC; (b) Super P; (c) Ketjen black (KB); (d) KS6L; (e) graphene; (f) Ketjen black+KS6L; (g) Super P+KS6L; (h) Super P+graphene; and (i) Super P in wet coating, in accordance with an embodiment of the present disclosure.

FIG. 2 depicts the (a) lower resolution and (b) higher resolution transmission electron microscopy (TEM) images of primary conductive carbon (KB) and secondary conductive carbon (KS6L) coated cathode surface.

### DESCRIPTION OF THE INVENTION

Those skilled in the art will be aware that the present disclosure is subject to variations and modifications other than those specifically described. It is to be understood that the present disclosure includes all such variations and modifications. The disclosure also includes all such steps, features, compositions, and compounds referred to or indicated in this specification, individually or collectively, and any and all combinations of any or more of such steps or features.

### Definitions

For convenience, before further description of the present disclosure, certain terms employed in the specification, and examples are delineated here. These definitions should be read in the light of the remainder of the disclosure and understood as by a person of skill in the art. The terms used herein have the meanings recognized and known to those of skill in the art, however, for convenience and completeness, particular terms and their meanings are set forth below.

The articles “a”, “an” and “the” are used to refer to one or to more than one (i.e., to at least one) of the grammatical object of the article.

The terms “comprise” and “comprising” are used in the inclusive, open sense, meaning that additional elements may be included. It is not intended to be construed as “consists of only”.

Throughout this specification, unless the context requires otherwise the word “comprise”, and variations such as “comprises” and “comprising”, will be understood to imply the inclusion of a stated element or step or group of element or steps but not the exclusion of any other element or step or group of element or steps.

The term “including” is used to mean “including but not limited to”. “Including” and “including but not limited to” are used interchangeably.

The term “w/w” means the percentage by weight, relative to the weight of the total composition, unless otherwise specified.

The term “at least one” is used to mean one or more and thus includes individual components as well as mixtures/combinations.

The term “current collector” refers to the electric bridging component, which collects electrical current generated at the electrodes of electrochemical devices and connect with external circuits. For the purpose of the present disclosure, the current collector includes but not limited to aluminium foil, glossy aluminium foils, carbon or polymer pre-coated aluminium foil or combinations thereof.

The term “binder” refers to the polymeric substance that provides adhesion and mechanical integrity to some extent, to the active material when loaded on a current collector to obtain an electrode. In the present disclosure, binder includes but not limited to polytetrafluoroethylene (PTFE), fluoroethylene vinyl ether (FEVE), or combinations thereof.

The term “BET surface area”, as used in refers to the Brunauer-Emmett-Teller measurement of an analyte's specific surface area (m²/g) through gas adsorption analysis, wherein an inert gas is continuously flowed over a solid sample, to analyze the total volume of gas adsorbed over the surface of the sample. According to the present disclosure, the primary conductive carbon has a BET surface area ranging from 250 m²/g to 1800 m²/g; and the secondary conductive carbon has a BET surface area ranging from 10 m²/g to 50 m²/g.

The term “cathode” refers to a positive electrode which is a dry battery electrode comprising: (a) at least one active material; (b) at least one primary conductive carbon having a BET surface area ranging from 250 m²/g to 1800 m²/g; (c) at least one secondary conductive carbon having a BET surface area ranging from 10 m²/g to 50 m²/g; and (d) at least one binder.

The term “conductive carbon” refers to the carbon-based additive added to an electrode composition to enhance the conductivity of the electrode. In the present disclosure, the conductive carbon comprises a primary and secondary conductive carbon. Additionally, conductive carbon of the present disclosure includes but is not limited to KS6L, Ketjen black or combinations thereof.

Ratios, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, temperature in the range of 80 to 120° C. should be interpreted to include not only the explicitly recited limits of 80 to 120° C. but also to include sub-ranges, such as 85 to 100° C., 97 to 119° C. and so forth, as well as individual amounts, including fractional amounts, within the specified ranges, such as 81.5° C., 100° C. and 119.9° C.

Unless defined otherwise, all technical and scientific terms used herein have the same meaning as commonly understood by one of ordinary skill in the art to which this disclosure belongs. Although any methods and materials similar or equivalent to those described herein can be used in the practice or testing of the disclosure, the preferred methods, and materials are now described. All publications mentioned herein are incorporated herein by reference.

The present disclosure is not to be limited in scope by the specific embodiments described herein, which are intended for the purposes of exemplification only. Functionally equivalent products, compositions, formulations, and methods are clearly within the scope of the disclosure, as described herein.

As discussed in the background, there is a dire need in the art to develop an efficient dry battery electrode, which exhibits high conductivity, better performance in aspects of improved discharge capacity, initial coulombic efficiency, capacity retention, and improved performance at high C rates in a range of 1 C to 2 C. To achieve the objective, the present disclosure provides a conductive carbon composition coated on the electrode surface, which gives better contact between the particles. Upon considering the major conductive carbon options such as Ketjen black, KS6L, graphene, amorphous carbon, Super-P, graphene oxide and carbon black, the present disclosure provides an optimised conductive carbon composition of Ketjen black, as a primary conductive carbon and KS6L, as a secondary conductive carbon in a weight ratio in the range of 15:1 to 2:1.

Conductive carbons such as Super-P with lower surface area are not able to cover the cathode surface more than 60% resulting in agglomeration of binder. In such case, the conductivity of the electrode is found to be low, while in few cases highly conductive agent such as graphene also shows lower conductivity after mixing as it might convert back to graphite under high shear force during mixing. KS6L having a lower surface area and lower conductivity provides lubrication to achieve flexible free standing electrode films. Additionally, Ketjen Black (KB) possessing high surface area provides higher conductivity to the electrode film and also covers more than 80% of cathode surface along with KS6L. KS6L having a lower surface area and high particle size covers around less than 80% of the surface of primary conductive carbon over the prolonged high-speed mixing. As KS6L covers less than 80% of the primary conductive carbon, the ionic diffusion during electrochemical cycling is not compromised. The differential particle size and differential surface area of Ketjen Black and KS6L ensures that the CAM comprises a coated layer of KB and then followed by a coated layer of KS6L over the KB. The combination of KS6L and Ketjen black, coated on the active material having smooth surface, provides a flexible free-standing electrode film with high conductivity. Overall, a cathode with combination of Ketjen black and KS6L as conductive carbon delivers higher discharge capacity with better initial coulombic efficiency.

Accordingly, in an embodiment of the present disclosure, there is provided a dry battery electrode comprising: (a) at least one active material; (b) at least one primary conductive carbon having a BET surface area ranging from 250 m²/g to 1800 m²/g; (c) at least one secondary conductive carbon having a BET surface area ranging from 10 m²/g to 50 m²/g; and (d) at least one binder.

In an embodiment of the present disclosure there is provided a dry battery electrode, wherein the dry battery electrode comprises at least one coated layer of the primary conductive carbon over the surface of the active material; and at least one coated layer of the secondary conductive carbon over the primary conductive carbon coated layer.

In an embodiment of the present disclosure, there is provided a dry battery electrode as disclosed herein, wherein the electrode is a cathode.

In an embodiment of the present disclosure, there is provided a dry battery electrode as disclosed herein, wherein the active material is selected from layered lithium nickel manganese cobalt oxide (LiₐNiₓMn_{y}Co_{z}MbO₂), spinel lithium nickel manganese oxide (LiNiMnM_{b}O₄), olivine lithium iron phosphate (LiFeM_{b}PO₄) or combinations thereof, wherein M is selected from Fe, Mn, Ni, Co, Cr, Al, Ti, Zr, W, Mo, Ru, V, Y, or Nb, a=0.9 to 1.3, b=0.01 to 0.5, x=0.1 to 0.9, y=0.01 to 0.7, and z=0.01 to 0.5; and the active material has a particle size in the range of 2 to 20 micron. In another embodiment of the present disclosure, the active material has a particle size in a range of 4 to 15 micron. In yet another embodiment of the present disclosure, the active material has a particle size in a range of 8 to 12 micron.

In an embodiment of the present disclosure, there is provided a dry battery electrode as disclosed herein, wherein the primary conductive carbon has a BET surface area in a range of 300 to 1500 m²/g; and the primary conductive carbon is ketjen black. In another embodiment of the present disclosure, the primary conductive carbon has a BET surface area preferably in a range of 600 to 1400 m²/g.

In an embodiment of the present disclosure, there is provided a dry battery electrode as disclosed herein, wherein the secondary conductive carbon has a BET surface area in a range of 10 to 40 m²/g; the secondary conductive carbon is KS6L. In another embodiment of the present disclosure, the secondary conductive carbon has a BET surface area preferably in a range of 15 to 25 m²/g.

In an embodiment of the present disclosure, there is provided a dry battery electrode as disclosed herein, wherein the binder is selected from polytetrafluoroethylene (PTFE), fluoroethylene vinyl ether (FEVE), or combinations thereof.

In an embodiment of the present disclosure, there is provided a dry battery electrode as disclosed herein, wherein the binder is polytetrafluoroethylene (PTFE).

In an embodiment of the present disclosure, there is provided a dry battery electrode as disclosed herein, wherein the active material is in a weight range of 96 to 98% (w/w) with respect to total weight of the electrode; the primary conductive carbon and the secondary conductive carbon are in a total weight range of 1 to 1.5% (w/w) with respect to total weight of the electrode; and at least one binder is in a weight range of 1 to 3.0% (w/w) with respect to total weight of the electrode.

In an embodiment of the present disclosure, there is provided a dry battery electrode as disclosed herein, wherein the primary conductive carbon and the secondary conductive carbon is in a weight ratio range of 15:1 to 2:1. In another embodiment of the present disclosure, the primary conductive carbon and the secondary conductive carbon is in a weight ratio range of 10:1 to 2:1. In yet another embodiment of the present disclosure, the primary conductive carbon and the secondary conductive carbon is in a weight ratio range of 5:1 to 2:1

In an embodiment of the present disclosure, there is provided a dry battery electrode as disclosed herein, wherein the primary conductive carbon to secondary conductive carbon has a surface area ratio in a range of 20:1 to 180:1. In another embodiment of the present disclosure, the primary conductive carbon to secondary conductive carbon has a surface area ratio in a range of 20:1 to 150:1. In another embodiment of the present disclosure, the primary conductive carbon to secondary conductive carbon has a surface area ratio in a range of 20:1 to 100:1.

In an embodiment of the present disclosure, there is provided a dry battery electrode as disclosed herein, wherein the primary conductive carbon is in a weight range of 0.9 to 1.4% (w/w) with respect to total weight of the electrode; and the secondary conductive carbon is in a weight range of 0.1 to 0.5% (w/w) with respect to total weight of the electrode.

In an embodiment of the present disclosure, there is provided a dry battery electrode as disclosed herein, wherein the primary conductive carbon has a particle size in a range of 10 to 70 nm; and the secondary conductive carbon has a particle size in a range of 1 to 5 μm.

In an embodiment of the present disclosure, there is provided a dry battery electrode as disclosed herein, wherein the coated layers of the primary and the secondary conductive carbons over the active material surface is in a thickness range of 5 to 35 nm and cover 80 to 95% of the active material surface.

In an embodiment of the present disclosure, there is provided a dry battery electrode as disclosed herein, wherein thickness of the primary conductive carbon coated layer over the active material surface is in a range of 2 to 15 nm.

In an embodiment of the present disclosure, there is provided a dry battery electrode as disclosed herein, wherein the thickness of the secondary conductive carbon coated layer over the primary conductive carbon coated layer is in a range of 3 to 20 nm.

In an embodiment of the present disclosure, there is provided a dry battery electrode as disclosed herein, wherein the electrode exhibits a through plane conductivity around 0.02 to 2.0 mS/cm at 25° C.; and a discharge capacity at 0.1 C rate is around 180-220 mAh/g at 25° C. In another embodiment, the electrode exhibits a through plane conductivity around 0.4 to 0.6 mS/cm at 25° C.; and a discharge capacity at 0.1 C rate around 200-220 mAh/g at 25° C.

In an embodiment of the present disclosure, there is provided a dry battery electrode comprising: (a) 96 to 98% (w/w) of at least one active material; (b) 1 to 1.5% (w/w) of (i) at least one primary conductive carbon, ketjen black having a BET surface area ranging from 250 m²/g to 1800 m²/g and (ii) at least one secondary conductive carbon, KS6L having a BET surface area ranging from 10 m²/g to 50 m²/g; and (c) at least one binder, polytetrafluoroethylene (PTFE).

In another embodiment of the present disclosure, there is provided a dry battery electrode comprising: (a) 96 to 98% (w/w) of at least one active material; (b) 1 to 1.5% (w/w) of (i) at least one coated layer of primary conductive carbon ketjen black over the surface of the active material, said primary conductive carbon having a BET surface area ranging from 250 m²/g to 1800 m²/g and (ii) at least one coated layer of a secondary conductive carbon KS6L over the primary conductive carbon coated layer, said secondary conductive carbon having a BET surface area ranging from 10 m²/g to 50 m²/g; and (c) at least one binder, polytetrafluoroethylene (PTFE).

In an embodiment of the present disclosure, there is provided a process to prepare a dry battery electrode as disclosed herein, said process comprising the steps of: (i) mixing at least one active material, at least one primary conductive carbon, and at least one secondary conductive carbon to obtain a first mixture; (ii) high speed mixing of the first mixture at a speed in a range of 2000 to 4000 rpm, at a temperature in a range of 20 to 40° C. to obtain a second mixture; (iii) adding at least one binder to the second mixture and mixing at a speed in the range of 1000 to 2000 rpm, followed by high shear mixing at a speed in a range of 2000 to 4000 rpm and at a temperature in a range of 50 to 120° C. to obtain a third mixture; and (iv) cooling the third mixture to a temperature less than 19° C. to obtain the electrode.

In an embodiment of the present disclosure, there is provided a process as disclosed herein, wherein the high speed mixing of at least one active material, at least one primary conductive carbon, and at least one secondary conductive carbon, is carried out for a time period in a range of 20 minutes to 120 minutes. In another embodiment, the high speed mixing is carried out for a time period in a range of 30 minutes to 120 minutes.

In an embodiment of the present disclosure, the high speed mixing of at least one active material, at least one primary conductive carbon, and at least one secondary conductive carbon results in the coating or layered structure of the primary conductive carbon with low particle size in the range of 10-70 nm on the active material surface. Further, the secondary conductive carbon with a flaky morphology and with a particle size of 1-5 micron coats over the primary conductive carbon, during the prolonged high speed mixing due to the micron level range of the active material and the secondary conductive carbon particle.

In another embodiment of the present disclosure, the high speed mixing of at least one active material, at least one primary conductive carbon, and at least one secondary conductive carbon results in at least one coated layer of the primary conductive carbon over the surface of the active material; and at least one coated layer of the secondary conductive carbon over the primary conductive carbon coated layer.

In an embodiment of the present disclosure, there is provided a process as disclosed herein, wherein the addition of at least one binder to the second mixture is performed at a temperature range of 20 to 30° C. for less than 30 minutes.

In an embodiment of the present disclosure, there is provided a process as disclosed herein, wherein the high shear mixing is carried out by Zeppelin high intensity mixer, jet milling or screw extrusion.

In an embodiment of the present disclosure, there is provided a process as disclosed herein, wherein the cooling of third mixture to a temperature less than 19° C. is carried out at a mixing speed in a range of 300 to 1000 rpm. In another embodiment of the present disclosure, the cooling of third mixture to a temperature less than 19° C. is carried out at a mixing speed in a range of 400 to 800 rpm. In another embodiment of the present disclosure, the cooling of third mixture to a temperature less than 19° C. is carried out at a mixing speed in a range of 500 to 700 rpm.

In an embodiment of the present disclosure, there is provided a process to prepare a dry battery electrode as disclosed herein, said process comprising the steps of: (i) mixing at least one active material, at least one primary conductive carbon, and at least one secondary conductive carbon to obtain a first mixture; (ii) high speed mixing of the first mixture at a speed in a range of 2000 to 4000 rpm, at a temperature in a range of 20 to 40° C. for a time period in a range of 20 minutes to 120 minutes to obtain a second mixture; (iii) adding at least one binder to the second mixture and mixing at a speed in the range of 1000 to 2000 rpm is performed at a temperature range of 20 to 30° C. for less than 30 minutes, followed by high shear mixing at a speed in a range of 2000 to 4000 rpm and at a temperature in a range of 50 to 120° C. to obtain a third mixture; and (iv) cooling the third mixture to a temperature less than 19° C. is carried out at a mixing speed in a range of 300 to 1000 rpm to obtain the electrode.

In an embodiment of the present disclosure, there is provided a process as disclosed herein, wherein the electrode is calendared to obtain a free-standing film and is followed by lamination of the film to the current collector at a temperature in a range of 60 to 150° C. In another embodiment of the present disclosure, the electrode is calendared to obtain a free-standing film and is followed by lamination of the film to the current collector at a temperature in a range of 80 to 150° C. In yet another embodiment of the present disclosure, the electrode is calendared to obtain a free-standing film and is followed by lamination of the film to the current collector at a temperature in a range of 120 to 150° C.

In an embodiment of the present disclosure, there is provided a process as disclosed herein, wherein the current collector is selected from a carbon pre-coated aluminium current collector, a polymer pre-coated aluminium current collector, or a mixture of carbon and polymer pre-coated aluminium current collector. In another embodiment of the present disclosure, the current collector is a carbon pre-coated aluminium current collector.

In an embodiment of the present disclosure, there is provided a process to prepare a dry battery electrode as disclosed herein, said process comprising the steps of: (i) mixing at least one active material, at least one primary conductive carbon, and at least one secondary conductive carbon to obtain a first mixture; (ii) high speed mixing of the first mixture at a speed in a range of 2000 to 4000 rpm, at a temperature in a range of 20 to 40° C. for a time period in a range of 20 minutes to 120 minutes to obtain a second mixture; (iii) adding at least one binder to the second mixture and mixing at a speed in the range of 1000 to 2000 rpm, at a temperature range of 20 to 30° C. for less than 30 minutes, followed by high shear mixing at a speed in a range of 2000 to 4000 rpm and at a temperature in a range of 50 to 120° C. to obtain a third mixture; (iv) cooling the third mixture to a temperature less than 19° C. at a mixing speed in a range of 300 to 1000 rpm to obtain the electrode and v) calendaring the electrode to obtain a free-standing film followed by lamination of the film to the current collector at a temperature in a range of 60 to 150° C. to obtain the electrode.

In an embodiment of the present disclosure, there is provided a lithium-ion battery comprising: (a) the dry battery electrode as disclosed herein as a cathode; (b) an anode; and (c) an electrolyte.

In another embodiment of the present disclosure, there is provided a lithium-ion battery comprising: (a) the dry battery electrode as a cathode, comprising: (i) at least one active material; (ii) at least one primary conductive carbon having a BET surface area ranging from 250 m²/g to 1800 m²/g; (iii) at least one secondary conductive carbon having a BET surface area ranging from 10 m²/g to 50 m²/g; and (iv) at least one binder; (b) an anode; and (c) an electrolyte.

In an embodiment of the present disclosure, there is provided a use of the dry battery electrode as disclosed herein, for energy storage applications.

Although the subject matter has been described in considerable detail with reference to certain examples and implementations thereof, other implementations are possible.

### EXAMPLES

The disclosure will now be illustrated with working examples, which is intended to illustrate the working of disclosure and not intended to take restrictively to imply any limitations on the scope of the present disclosure. Unless defined otherwise, all technical and scientific terms used herein have the same meaning as commonly understood to one of ordinary skill in the art to which this disclosure belongs. Although methods and materials similar or equivalent to those described herein can be used in the practice of the disclosed methods and compositions, the exemplary methods, devices, and materials are described herein. It is to be understood that this disclosure is not limited to particular methods, and experimental conditions described, as such methods and conditions may apply.

### Materials and Methods

The procurement details of various chemicals and solvents used in the present disclosure are as follows:
1. Cathode active material was procured from BASE
2. Primary conductive carbon-ketjen black (BET surface area: 600 m²/g; particle size 15 to 80 nm) was procured from Nouryon.
3. Secondary conductive carbon KS6L (BET surface area: 20 m²/g; particle size 1 to 6 μm) was procured from Imerys.
4. Other conductive carbons, such as SuperP (BET surface area: 60 m²/g; particle size 15 to 80 nm), graphene (BET surface area: 300 m²/g; particle size 30 to 200 nm), carbon black (BET surface area: 62 m²/g; particle size 15 to 80 nm) were procured from Imerys.
5. Binder: PTFE was procured from Daikin.
6. Pre-coated aluminium Current collector was procured from Armor.

### Example 1

### Preparation of the Cathode

Ninety seven percentage (97%) by weight of an active material (AM)-layered lithium nickel manganese cobalt oxide having the average particle size of 10 micron, 1% by weight of a primary conductive carbon (CC1)—Ketjen black and 0.5% by weight of a secondary conductive carbon (CC2)—KS6L, were mixed for 15 minutes in a Zeppelin mixture at a speed of 300 rpm, to obtain a first mixture. The first mixture was subjected to high speed mixing at a speed of 3000 rpm, at a temperature of 30° C. for two hours to obtain a second mixture. A binder (B) polytetrafluoroethylene (PTFE) of weight of 1.5% was added to the second mixture and mixed at a speed of 1500 rpm for 20 minutes to achieve uniform distribution at lower temperature <30° C. The uniform mixture was then high shear mixed using a Zeppelin high intensity mixer at a speed of 3000 rpm until temperature reached 70° C. to obtain a third mixture. The third mixture was then cooled to a temperature less than 19° C. at a speed of 600 rpm to obtain the electrode.

Further, the electrode was calendered to obtain a free-standing film and was followed by lamination of the film to the carbon pre-coated aluminium current collector at a temperature of 150° C. to obtain an electrode. Thus, various cathodes (S1 to S16) have been prepared by appropriately changing primary and secondary conductive carbon combinations as listed in Table 1.

### Example 2

### Characterization of the Cathode

### A. Scanning Electron Microscopic (SEM) Analysis

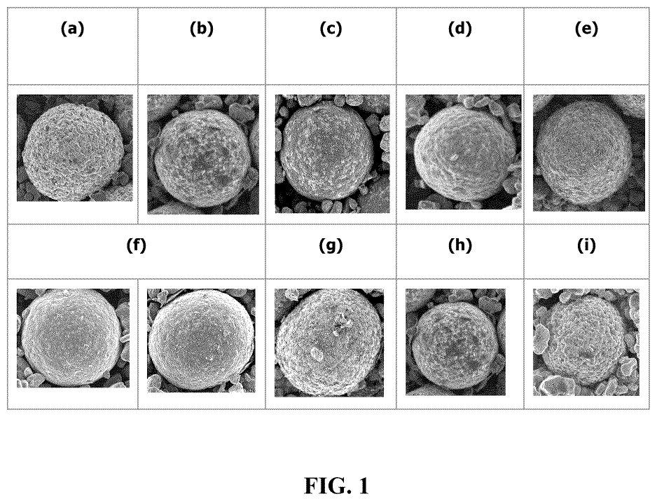

The coated layer of conductive carbon over the active material was analyzed using SEM analysis. The SEM images (FIG. 1a-1i) of various combinations of conductive carbons were taken and compared. From the analysis, the conductive carbon combination of Ketjen black and KS6L exhibited better coverage of more than 80% (FIG. 1f). In addition, uniformly coated layer of conductive carbon was observed on the surface of NMC (covers 80 to 95%) after 2 hours of premixing at 3000 rpm.

The coated layer of conductive carbon on cathode surface images are shown in the FIG. 1, where uncoated NMC cathode (FIG. 1a) was differentiated from carbon coated NMC cathode. All the images were produced at similar mixing conditions, where Super-P and its combination with KS6L (FIG. 1g) and Graphene (FIG. 1h) showed partial surface coating of the NMC cathode polycrystal. In these mentioned electrodes, the surface was covered around 40-60%. The surface coated carbon agglomerated once when it was mixed with binder owing to the higher binder-carbon attraction compared to carbon-active material attraction. Hence, more than 60% of the surface area of the cathode was expected to be covered by carbon. Here in case of combination of Ketjen Black and KS6L (FIG. 1f), more than 80% of the cathode active material surface was covered by conductive carbons and it retained even after mixing with PTFE. Therefore, it showed better conductive contact between the cathode particles.

### B. Transmission Electron Microscopic (TEM) Analysis

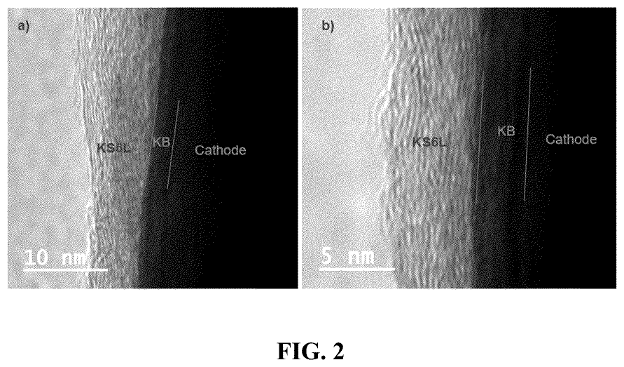

The coated layer of conductive carbon over the active material was analyzed using TEM. The TEM images (FIGS. 2a and 2b) of cathode comprising the coated layers of primary and secondary conductive carbon over the active material particles were taken and compared. From the analysis, the conductive carbon combination of Ketjen black and KS6L exhibited better coverage of more than 80%. In addition, uniformly coated layer of carbon was observed on the surface.

Primary conductive carbon (Ketjen Black—KB) and secondary conductive carbon (KS6L) was found form a uniformly coated layer on the surface of cathode material in a range of 5 to 35 nm. The primary conductive carbon formed a coated layer on the surface of the cathode material and the secondary conductive carbon formed a coated layer on the surface of the primary conductive carbon. The thickness of the primary carbon coated layer varied from 2 to 15 nm and the thickness of the secondary conductive carbon coated layer was in the range of 3 to 20 nm. The primary conductive carbon was found to be helpful in increasing the conductivity and anchoring the PTFE binder, whereas secondary carbon facilitated lubrication and additionally increased the conductivity.

### C. Conductivity Measurement

Various electrochemical properties of the prepared electrode with varied combinations of different types of conductive carbon (S1 to S16) were assessed and the results are provided in Table 1.

The through plane conductivity was analysed by studying conductivity in the direction perpendicular to the plane of the electrode film with two probe electrode system. The various electrodes exhibited a through plane conductivity around 0.02 to 2.0 mS/cm at 25° C. Specifically, the electrode with the combination of KB and KS6L as conductive carbons exhibited a through plane conductivity around 0.47 to 0.57 (S8,S9, and S15).

The C-rate represents the rate at which level the battery is providing energy. The higher power with a higher discharge rate (C-rate). 1 C means that the battery is fully charged and discharged within one hour, 2 C is 30 minutes, 1° C. is 6 mins, 100 C is 6 seconds. The electrode exhibited a discharge capacity at 0.1 C rate around 180-220 mAh/g at 25° C. as shown in Table 1.

### D. Mechanical Strength Analysis

### Tensile Strength

Tensile strength analysis was performed for the electrodes prepared as in Example 1.

The term “tensile strength” refers to the largest force in weight per unit area tugging in the direction of length that a given substance can sustain without rupturing. Tensile strength is also described as the “resistance to lengthwise stress.” A tensile test (or tension test) applies force to a material specimen in order to measure the material's response to tensile (or pulling) stress. A material either fully or partially cannot be reverted to its former shape and size once the stress approaches the tensile strength value. Force per unit area is a measure of tensile strength. The required length (200-250 mm), width (25-30 mm) and thickness (60-80 μm) of dry electrode has been prepared for the tensile strength measurement. The prepared dry electrode was fixed in the fixtures and the load was applied with cross-section speed of 12.5 mm/min. Load versus displacement curve was plotted to obtain the yield strength, and tensile strength values are of the dry electrode.

The tensile strength for the electrodes using varied combination of conductive carbons was found to be in a range of 200-350 kgf/cm². The combination of KB and KS6L as conductive carbons exhibited a tensile strength of 300-350 kgf/cm² (S8, S9, and S15).

### Peel Strength Analysis

Peel strength analysis is a conventional method in battery industry for ranking the adhesion strength of electrodes. For the test, a double-sided adhesive tape was first stuck onto the movable pull-off table. The composite to be tested was then glued to the adhesive tape. Subsequently, one of the two connected (glued) components was attached to the load cell using a tension clamp, which was integrated in the movable measuring arm of the testing device. During the test, the measuring arm moved upwards, separating the two materials adhering to each other at an angle of 90°. The congruent movement of the table maintained the 90° angle during the measurement. The pull-off speed was varied. The pull-off force standardized to the width of the test strip is called peel strength and is usually given in N/mm. After measuring and averaging the load required to peel the specimen, the peel strength is derived by dividing the average load by the bond line's unit width.

The active material coating was separated from the current collector using bond tapes at a speed of about 0.01 mm/s to 40 mm/s to obtain an electrode of peel strength in a range of 0.04-0.1 N/cm². Specifically, the combination of KB and KS6L as conductive carbons exhibited a peel strength of 0.07 to 0.09 N/cm² as evident in electrodes S8,S9 and S15. (Table 1).

### E. Cyclovoltammetry Analysis

Cyclic voltammetric (CV) analysis of electrochemical cells containing the cathode prepared by the process as explained in example 1; an electrolyte (1M LiPF₆ in EC(ethylene carbonate):DMC (dimethyl carbonate):EMC (ethyl methyl carbonate); an additive <1% (VC (vinylene carbonate):PS (1,3-propane sultone):SN (succinonitrile):LiBF₄) and an anode (Li) was carried out at a scan rate of (0.1 C). Cyclic voltammetry (CV) and galvanostatic charge/discharge measurements were conducted in the form of a coin cell. CVs of the samples were measured from 2.5 and 4.3 V.

Galvanostatic charge-discharge cycles at a potential window of 2.5 V to 4.3 V was recorded for the cell of the present disclosure, obtained by the process as explained in example 2 at a current rate of 0.1 C. The cycling was performed at a temperature range of 25° C. and 45° C.

The Discharge capacity of the cell comprising the cathode comprising only the primary conductive carbon of graphene (mAh/g) at 0.1 C rate exhibited a lower value. In comparison to the combination of primary conductive carbon as super P (SP), carbon black (CB) (S5 and S6), the combination of primary conductive carbon as Ketjen Black (KB) and secondary conductive carbon as KS6L showed better discharge capacity at 2 C rate as shown in below table 1.

The retention of the cathode was also analyzed after 50 cycles at 1 C, to find out that appreciable cycle stability was exhibited by the cathodes comprising secondary and primary conductive carbon as KB and KS6L in the disclosed ratios. Also, the combination of KB and KS6L as conductive carbons in the electrode resulted in an ICE value of 92.72%, as is evident in electrode S9 in table 1.

Overall, the combination of Ketjen black and KS6L as the primary and secondary conductive carbons (as in electrodes S8, S9 and S15), respectively resulted in an electrode with improved electrochemical performance, when compared to other combinations (S1, S2, S3, S4, S5, and S6).

Further, it is essential that the total weight of Ketjen black and KS6L as the primary and secondary conductive carbons, respectively, is maintained within the range of 1% to 1.5%. As seen in Table 1, electrodes S13 and S14 with the total weight of conductive carbon being less than 1% exhibited inferior electrochemical performance, as is evident from the respective discharge capacity values. Also, if the weight of primary or secondary conductive carbon is outside the optimal weight range, the electrodes thus obtained are not of desired electrochemical performance. For example, the electrodes S10, S11, S12, S13 and S14 have a primary conductive carbon of less than 0.9% by weight and which exhibits poor electrochemical performance when compared to S8, S9, and S15 electrodes, as is evident from the corresponding discharge capacity at 2 C rate values. Similarly, S7 has a primary conductive carbon weight of more than 1.4% and secondary conductive carbon with a weight below 0.1%, which also results in inferior performance.

Collectively, the specific combination of conductive carbons and in specific weight percentage is essential to obtain a dry battery electrode with superior electrochemical performance. Any deviations from the disclosed weight range or the combinations of conductive carbons will not result in the desired electrochemical performance of the dry battery electrode.

TABLE 1

| | | | | | Discharge | | | Discharge |
|---|---|---|---|---|---|---|---|---|
| | | | Through | | capacity | | Retention | Capacity |
| | Formulation | Peel | plane | Tensile | (mAh/g) | | after 50 | (mAh/g) |
| Sl. | AM:CC1: | Strength | Conductivity | Strength | @ 0.1 C | ICE | cycles at | at 2 C |
| No. | CC2:B | (N/cm²) | (mS/cm) | (Kgf/cm²) | rate | (%) | 1 C | rate |
| S1 | AM: | 0.040 | 0.00002 | 284 | 191.87 | 84.96 | 60.22 | 44.45 |
| | Graphene: | | | | | | | |
| | Nil:PTFE | | | | | | | |
| | 97:1.5:0.0: | | | | | | | |
| | 1.5 | | | | | | | |
| S2 | AM:SP: | 0.056 | 0.033 | 303 | 210.0 | 91.0 | 63.75 | 77.79 |
| | Nil:PTFE | | | | | | | |
| | 97:1.5:0.0: | | | | | | | |
| | 1.5 | | | | | | | |
| S3 | AM:KS6L: | 0.037 | 0.020 | 283 | 209.11 | 91.59 | 45.93 | 54.32 |
| | Nil:PTFE | | | | | | | |
| | 97:1.5:0.0: | | | | | | | |
| | 1.5 | | | | | | | |
| S4 | AM:SP: | 0.050 | 0.0002 | 276 | 211.47 | 91.75 | 32.41 | 37.39 |
| | Graphene: | | | | | | | |
| | PTFE | | | | | | | |
| | 97:1.0:0.5: | | | | | | | |
| | 1.5 | | | | | | | |
| S5 | AM:SP: | 0.053 | 0.056 | 325 | 208.07 | 91.30 | 35.92 | 50.66 |
| | KS6L:PTFE | | | | | | | |
| | 97:1.0:0.5: | | | | | | | |
| | 1.5 | | | | | | | |
| S6 | AM:CB: | 0.043 | 0.065 | 315 | 208.04 | 91.30 | 38.89 | 56.56 |
| | KS6L:PTFE | | | | | | | |
| | 97:1.0:0.5: | | | | | | | |
| | 1.5 | | | | | | | |
| S7 | AM:KB: | 0.064 | 0.35 | 342 | 211.35 | 91.11 | 85.36 | 107.25 |
| | Nil:PTFE | | | | | | | |
| | 97:1.5:0.0: | | | | | | | |
| | 1.5 | | | | | | | |
| S8 | AM:KB: | 0.086 | 0.57 | 350 | 210.35 | 91.12 | 90.30 | 157.74 |
| | KS6L:PTFE | | | | | | | |
| | 97:1.0:0.5: | | | | | | | |
| | 1.5 | | | | | | | |
| S9 | AM:KB: | 0.091 | 0.47 | 329 | 215.35 | 92.72 | 93.30 | 167.42 |
| | KS6L:PTFE | | | | | | | |
| | 97.2:1.0:0.3: | | | | | | | |
| | 1.5 | | | | | | | |
| S10 | AM:KB: | 0.05 | 0.14 | 291 | 206.3 | 91.95 | 55.20 | 57.93 |
| | KS6L:PTFE | | | | | | | |
| | 97.5:0.5:0.5: | | | | | | | |
| | 1.5 | | | | | | | |
| S11 | AM:KB: | 0.045 | 0.25 | 302 | 207.08 | 91.85 | 65.40 | 74.56 |
| | KS6L:PTFE | | | | | | | |
| | 97:0.75:0.75: | | | | | | | |
| | 1.5 | | | | | | | |
| S12 | AM:KB: | 0.04 | 0.12 | 289 | 212.18 | 92.25 | 44.60 | 64.31 |
| | KS6L:PTFE | | | | | | | |
| | 97:0.5:1.0: | | | | | | | |
| | 1.5 | | | | | | | |
| S13 | AM:KB: | 0.08 | 0.2 | 273 | 201.5 | 90.76 | 35.26 | 20.66 |
| | KS6L:PTFE | | | | | | | |
| | 97.75:0.5:0.25: | | | | | | | |
| | 1.5 | | | | | | | |
| S14 | AM:KB: | 0.08 | 0.13 | 334 | 213.6 | 91.96 | 30.02 | 87.07 |
| | KS6L:PTFE | | | | | | | |
| | 97.75:0.5: | | | | | | | |
| | 0.25:1.5 | | | | | | | |
| S15 | AM:KB: | 0.075 | 0.53 | 340 | 215.6 | 92.26 | 90.12 | 167.5 |
| | KS6L:PTFE | | | | | | | |
| | 97:1.2:0.3: | | | | | | | |
| | 1.5 | | | | | | | |
| S16 | Wet | 0.015 | 1.55 | 218 | 210 | 91.00 | 93.5 | 175 |
| | electrode | | | | | | | |

### Example 3

### Preparation of Electrochemical Cell

This example illustrates the preparation of an electrochemical cell comprising the electrode as prepared in Example 1 of the present disclosure.

The electrochemical cell setup was obtained by assembling the sequentially stacked pellets of cathode prepared by the method as explained in example 1, and an anode on either side of an electrolyte.

An electrochemical cell specifically a battery, and more specifically, a lithium-ion battery was prepared. The lithium-ion battery includes a cathode (positive electrode) of the dry battery electrode as explained in example 1, an anode disposed to face the cathode, and an electrolyte placed between cathode and anode. The electrochemical cell obtained from the process explained above was analyzed for its electrochemical performance, C-rate performance, cycle-thermal stability, and capacity.

### ADVANTAGES OF THE PRESENT DISCLOSURE

The present disclosure provides a combination of conductive carbons that provides better contact between particles and better coverage over the active materials. The present disclosure hence provides a dry battery cathode comprising Ketjen black and KS6L as conductive carbon, which shows high conductivity, better performance in aspects of improved discharge capacity, initial coulombic efficiency, capacity retention, and improved performance at high C rates in a range of 1 C to 2 C. Compared to other carbon formulations, Ketjen black and KS6L provides an uniformly coated layer over cathode and exhibits high point of contact between the particles. Hence, the use of Ketjen black and KS6L shows high conductivity and substantially helps in anchoring the PTFE over electrode mixture to provide freestanding flexible high tensile and peel strength electrode film. In addition, a process for preparing the same is also provided in the present disclosure. Overall, the cathode with the combination of Ketjen black and KS6L delivers discharge capacity of 215 mAh/g with 93% initial coulombic efficiency.

1. A dry battery electrode comprising:
a. at least one active material;
b. at least one primary conductive carbon having a BET surface area ranging from 250 m²/g to 1800 m²/g;
c. at least one secondary conductive carbon having a BET surface area ranging from 10 m²/g to 50 m²/g; and
d. at least one binder.

2. The dry battery electrode as claimed in claim 1, wherein the dry battery electrode comprises at least one coated layer of the primary conductive carbon over the surface of the active material; and at least one coated layer of the secondary conductive carbon over the primary conductive carbon coated layer.

3. The dry battery electrode as claimed in claim 1, wherein the electrode is a cathode.

4. The dry battery electrode as claimed in claim 1, wherein the active material is selected from layered lithium nickel manganese cobalt oxide (LiₐNiₓMn_{y}Co_{z}M_{b}O₂), spinel lithium nickel manganese oxide (LiNiMnM_{b}O₄), olivine lithium iron phosphate (LiFeM_{b}PO₄) or combinations thereof, wherein M is selected from Fe, Mn, Ni, Co, Cr, Al, Ti, Zr, W, Mo, Ru, V, Y, or Nb, a=0.9 to 1.3, b=0.01 to 0.5, x=0.1 to 0.9, y=0.01 to 0.7, and z=0.01 to 0.5; and the active material has a particle size in a range of 2 to 20 micron.

5. The dry battery electrode as claimed in claim 1, wherein the primary conductive carbon has a BET surface area in a range of 300 to 1500 m²/g; and the primary conductive carbon is ketjen black; and the secondary conductive carbon has a BET surface area in a range of 10 to 40 m²/g; and the secondary conductive carbon is KS6L.

6. (canceled)

7. The dry battery electrode as claimed in claim 1, wherein the binder is selected from polytetrafluoroethylene (PTFE), fluoroethylene vinyl ether (FEVE), or combinations thereof.

8. (canceled)

9. The dry battery electrode as claimed in claim 1, wherein the active material is in a weight range of 96 to 98% (w/w) with respect to total weight of the electrode; the primary conductive carbon and the secondary conductive carbon are in a total weight range of 1 to 1.5% (w/w) with respect to total weight of the electrode; and the at least one binder is in a weight range of 1 to 3.0% (w/w) with respect to total weight of the electrode.

10. The dry battery electrode as claimed in claim 1, wherein the primary conductive carbon and the secondary conductive carbon is in a weight ratio range of 15:1 to 2:1.

11. The dry battery electrode as claimed in claim 1, wherein the primary conductive carbon to secondary conductive carbon has a surface area ratio in a range of 20:1 to 180:1.

12. The dry battery electrode as claimed in claim 1, wherein the primary conductive carbon is in a weight range of 0.9 to 1.4% (w/w) with respect to total weight of the electrode and the secondary conductive carbon is in a weight range of 0.1 to 0.5% (w/w) with respect to total weight of the electrode.

13. The dry battery electrode as claimed in claim 1, wherein the primary conductive carbon has a particle size in a range of 10 to 70 nm; and the secondary conductive carbon has a particle size in a range of 1 to 5 μm.

14. The dry battery electrode as claimed in claim 2, wherein the coated layers of the primary and the secondary conductive carbons over the active material surface is in a thickness range of 5 to 35 nm and cover 80 to 95% of the active material surface.

15. The dry battery electrode as claimed in claim 2, wherein thickness of the primary conductive carbon coated layer over the active material surface is in a range of 2 to 15 nm; and the thickness of the secondary conductive carbon coated layer over the primary conductive carbon coated layer is in a range of 3 to 20 nm.

16. (canceled)

17. The dry battery electrode as claimed in claim 1, wherein the electrode exhibits a through plane conductivity around 0.02 to 2.0 mS/cm at 25° C.; and a discharge capacity at 0.1 C rate around 180-220 mAh/g at 25° C.

18. A process to prepare a dry battery electrode as claimed in claim 1, said process comprising the steps of:
i) mixing at least one active material, at least one primary conductive carbon, and at least one secondary conductive carbon to obtain a first mixture;
ii) high speed mixing of the first mixture at a speed in a range of 2000 to 4000 rpm, at a temperature in a range of 20 to 40° C. to obtain a second mixture;
iii) adding at least one binder to the second mixture and mixing at a speed in the range of 1000 to 2000 rpm, followed by high shear mixing at a speed in a range of 2000 to 4000 rpm and at a temperature in a range of 50 to 120° C. to obtain a third mixture; and
iv) cooling the third mixture to a temperature less than 19° C. to obtain the electrode.

19. The process as claimed in claim 18, wherein the high speed mixing of at least one active material, at least one primary conductive carbon, and at least one secondary conductive carbon, is carried out for a time period in a range of 20 minutes to 120 minutes.

20. The process as claimed in claim 18, wherein the addition of at least one binder to the second mixture is performed at a temperature range of 20 to 30° C. for less than 30 minutes.

21. The process as claimed in claim 18, wherein the cooling of the third mixture to a temperature less than 19° C. is carried out at a mixing speed in a range of 300 to 1000 rpm.

22. The process as claimed in claim 18, wherein the electrode is calendered to obtain a free-standing film and is followed by lamination of the free-standing film to a carbon pre-coated current collector at a temperature in a range of 60 to 150° C.

23. A lithium-ion battery comprising:
a. the dry battery electrode as claimed in claim 1 as a cathode;
b. an anode; and
c. an electrolyte.
